(19) United States
(12) Patent Application Publication
(10) Pub. No.: US 2003/0225600 A1
(43) Pub. Date: Dec. 4, 2003

(54) Methods, systems, and articles of manufacture for re-accommodating passengers following a travel disruption

(76) Inventors: Daria M. Slivka, Dallas, TX (US); Kyle Morris, Grand Prairie, TX (US); James Timothy Chancey, Cedar Hill, TX (US); Anomah Ngu, Keller, TX (US); Barry C. Smith, Flower Mound, TX (US); Michael Clarke, Irving, TX (US); Ladislav Lettovsky, Trophy Club, TX (US); Russell L. Strothmann, Broken Arrow, OK (US); Venkata Nagireddy, Galveston, TX (US); Amela Abadzic-Ovcina, Plano, TX (US); Dianne R. McQuarrie, Tulsa, OK (US)

Correspondence Address: GUY R. GOSNELL , ESQ., ALSTON & BIRD LLP, 101 SOUTH TRYON STREET, SUITE 4000, BANK OF AMERICA PLAZA, CHARLOTTE, NC, 28280-4000, US

(21) Appl. No.: 10/252,608

(22) Filed: Sep. 24, 2002

Related U.S. Application Data
(60) Provisional application No. 60/324,098, filed on Sep. 24, 2001.

(51) Int. Cl. G06F 17/60

(52) U.S. Cl. 705/5

(57) ABSTRACT

Methods, systems, and articles of manufacture consistent with certain principles related to the present invention determine an impact of schedule changes on passenger flow and re-accommodate disrupted passengers. A passenger flow re-accommodation process is performed that determines a value for a disrupted passenger based on selected criteria and rules that may be established by travel service providers. The value and available travel service information are used by the process to rebook the disrupted passenger on a selected alternative itinerary. A notification of a successful rebooking may be provided to the disrupted passenger and/or the travel service provider.

### CROSS REFERENCE TO RELATED APPLICATION

This application is related to and claims the benefit of priority under 35 U.S.C. 119(e) to U.S. Provisional Patent Application No. 60/324,098, filed on Sep. 24, 2001, the disclosure of which is expressly incorporated herein by reference in its entirety.

### FIELD OF INVENTION

This invention relates to managing passenger accommodations in a transportation network, and more particularly, to methods, systems, and articles of manufacture for re-accommodating passengers following a disruption in travel services.

### BACKGROUND OF THE INVENTION

Optimization (i.e., the efficient utilization) of assets used in the physical transport of persons and commodities, presents an ongoing challenge to organizations involved in transportation services. Strategic and operational planning for transportation services are highly complex problems. Computer-based decision support systems are typically utilized to help deal with this complexity. These systems facilitate the planning of schedules, routes, aircraft and crew rotations, yield management, and passenger flow. These support systems are also vital within the hotel industry, car rental, cruise, and other travel related businesses that furnish services to a large and growing number of customers.

One of the realities of transportation services, such as airline services, is that operational flight delays or cancellations are quite common. These irregularities may apply to a single flight or a network of flights on any given day depending upon the nature of the cause of the disruption. A mechanical difficulty may disrupt a single flight, while weather or other factors may disrupt many flights. These flight irregularities may sometimes force passengers to alter their immediate transportation plans and force airlines to revise their schedule of operational flights for the current day. These revised operational schedules may cause problems for a particular airline because the airline was not prepared for the change in the immediate day's passenger flow created by the mishap. Further, a schedule disruption can have an adverse effect on the reservations of ancillary travel services, such as, but not limited to, car rentals, hotel reservations, and tour services. Very little research work has been published on the problems of assessing the impact of operational schedule changes on passenger flow. Some related work has been done on passenger flow from the perspective of revenue management. This work, however, dealt mainly with balancing the rewards with filling seats that would otherwise be empty with low-fare passengers that an airline would otherwise not have carried against the risks of displacing higher-fare passengers that would otherwise have been carried. Also, this work does not reflect disruptions in the current day's activities.

### SUMMARY OF THE INVENTION

Accordingly, there is a present need for a system and a method that is capable of assessing the impact of an operational schedule disruption on passenger flow and re-accommodating displaced passengers according to the passengers' value to a travel service provider and/or a travel selling agent external to the travel provider. Such an invention is needed for both single or multiple flight disruptions.

Methods, systems, and articles of manufacture consistent with certain principles related to the present invention may determine the impact of schedule changes and operational disruptions on passenger flow and how affected passengers may be re-accommodated with respect to their value established by airlines, ancillary services, and/or commodities, such as hotel and car reservations.

In one configuration consistent with certain principles related to the present invention, passenger groups may be created based on respective locations and destinations of passengers affected by a transportation irregularity, such as a current day flight cancellation. A set of alternative paths though an airline network and ancillary related commodities are generated for each group of passengers. The airline network may include operational schedule changes in transportation options as well as possible schedule changes in ancillary travel related commodities. The affected passengers may then be re-accommodated according to passenger revenue and profile ranking value rules established and maintained by travel providers and/or travel related agents.

Additionally, methods, systems, and articles of manufacture consistent with certain principles related to the present invention generate alternative paths through the network for each passenger group based on an optimization-based model. The impact of schedule changes and travel options for affect passengers are determined through the optimization-based model based on, among other things, ancillary commodities and relative passenger value.

Additional aspects of the invention will be set forth in part in the description which follows, and in part will be obvious from the description, or may be learned by practice of methods, systems, and articles of manufacture consistent with features of the present invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention. In the

FIG. 1 illustrates an exemplary system environment, consistent with features and principles of the present invention;

FIG. 2 illustrates a flowchart of an exemplary process that may be performed by methods, systems, and articles of manufacture consistent with features and principles of the present invention; and

FIG. 3 illustrates a flowchart of an exemplary re-accommodation process that may be performed by methods, systems, and articles of manufacture consistent with features and principles of the present invention.

### DETAILED DESCRIPTION

### Overview

Methods, systems, and articles of manufacture consistent with certain principles related to the present invention performs a passenger flow model re-accommodation process that re-accommodates passengers affected by a change in a travel itinerary. This process assesses an origin-destination and ancillary commodity impact of an operational schedule change with respect to a travel service provider (e.g., airline, travel agent service, tour service, etc.) and a determined business value of the passenger. An operational schedule change, as used herein, is associated with a change in an itinerary based on an operation disruption that occurs within a close proximity of time (e.g., 24 hours) of a scheduled travel event, such as a scheduled departure or arrival time of one or more airline flights. An operational disruption, as used herein, is associated with an event that causes a travel service to be altered (e.g., cancelled, delayed, etc.). For example, an operational disruption may be associated with mechanical problems and weather and/or disaster conditions that may affect one or more travel services. Accordingly, the passenger flow model re-accommodation process determines how to move a disrupted passenger from a passenger's origin or an en route location to their intended destination using one or more alternate travel services. A disrupted passenger, as used herein, is associated with an individual that has a booked, scheduled, or reserved opportunity to receive a travel service, such as a booked seat on an airline, train, tour bus, etc.

In one aspect of the invention, a disrupted passenger may be re-accommodated based on an overall value of the passenger's aggregate business compared to other passengers on a same disrupted travel service (e.g., flight). The process maximizes long-term recovered passenger revenue through optimal reassignments of available seats to disrupted passengers as well as additional measures of individual passenger re-accommodation in the aftermath of an operational disruption, including ancillary travel services such as hotel, car rental, etc. The process also maximizes the number of passengers who are accommodated on an original carrier and thus minimizes the provider cost of moving passengers to a different airline or an ancillary travel provider.

Reference will now be made in detail to the exemplary aspects of the invention, examples of which are illustrated in the accompanying drawings. Wherever possible, the same reference numbers will be used throughout the drawings to refer to the same or like parts.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

### Computer Environment

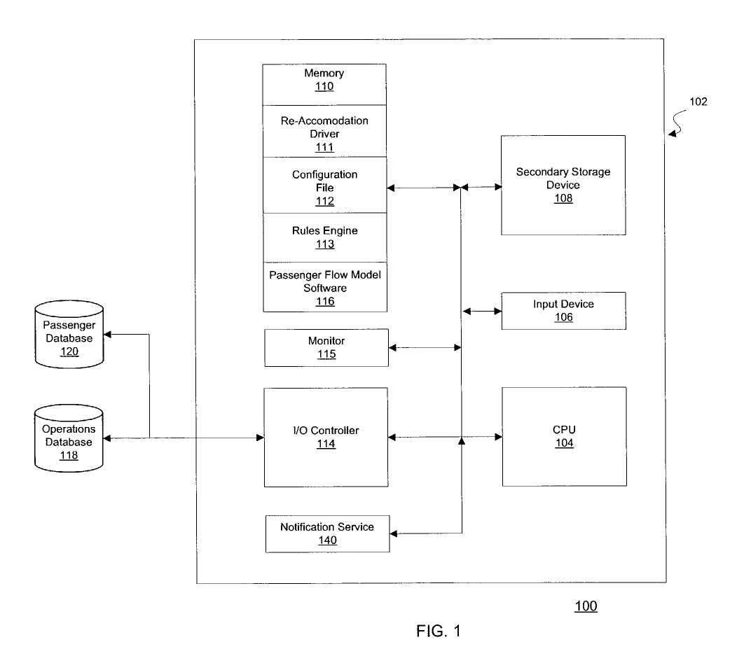

FIG. 1 is a diagram of a partially expanded view of an exemplary computer environment 100 in which certain features and aspects consistent with the present invention may be implemented. As shown, computer environment 100 may comprise re-accommodation computer 102 (“computer 102”), operations database 118, and passenger database 120. Computer 102 may include a mainframe, server, client, personal computer, workstation, laptop, personal digital assistant or any other similar computer system known in the art. Computer 102 may comprise central processing unit (CPU) 104, input device 106, secondary storage device 108, memory 110, monitor 115, I/O controller 114, and notification service 140.

CPU 104 may be any type of processor (or processors) known in the art. CPU 104 may be configured to executed instructions and perform processes consistent with certain principles related to the present invention. Although FIG. 1 shows only one CPU 104 included with computer 102, one skilled in the art would realize that a number of different architectures may be implemented by methods, systems, and articles of manufacture consistent with certain features related to the present invention. For example, CPU 104 may be replaced, or supplemented, by a plurality of processors that perform multi-tasking operations.

Input device 106 may be any known computing component that allows computer 102 to receive information, for example, from a user, such as a keyboard, mouse, pointing device, external network connection, and any other similar components known in the art. Secondary storage device 108 and memory 110 may be any known type of storage device that stores data. Secondary storage device 108 and memory 110 may include, but are not limited to, magnetic, semiconductor, and/or optical type storage devices. Secondary storage device 108 and memory 110 may also be storage devices that allows CPU 104 quick access to data, such as a cache memory. In one configuration consistent with selected features related to the present invention, memory 110 and secondary storage device 108 may store data and/or program instructions to implement methods consistent with certain features related to the present invention.

Memory 110 may further comprise re-accommodation driver 111, configuration file 112, rules engine 113, and passenger flow model software 116. One skilled in the art would realize that these components of memory 110 may be located external to memory 110 and/or computer 102, and perform processes consistent with certain features related to the present invention when executed by a processor, for example, CPU 104.

Re-accommodation driver 111 may be a set of instructions that, when executed by CPU 104, perform a process that manages and performs re-accommodation functions consistent with the present invention. Configuration file 112 may be a data structure (e.g., file) that includes disrupted travel information, such as cancelled flight data. Configuration file 112 may be updated by computer 102 each time a disruption (e.g., operational disruption) occurs to a travel service, for instance when a flight is cancelled. Computer 102 may be configured to receive indications of one or more operational disruptions from an external entity that maintains the current status of travel services provided by one or more travel service providers and update configuration file 112 accordingly.

Rules engine 113 may be a set of instructions, that when executed by a processor (e.g., CPU 104) perform a process that determines values associated passengers based on one or more travel rules. In one aspect of the rules may be defined by a travel service provider, agency, and any other entity associated with the travel industry, such as a hotel and tour service entity. The rules may be based on passenger profile information and possibly maintained in a passenger history, behavior, and/or profile database. For example, rules engine 113 may associate a data code reflecting a type of travel status of a passenger, such as a frequent flyer status. Table 1 shows an exemplary listing of various values associated with a code called frequentFlyerStatus that indicates the participation of a passenger on a particular carrier in a travel network.

TABLE 1
frequentFlyerStatus Codes

| | |
|---|---|
| 1 | Passenger has no flyer information. |
| 2 | Passenger has a history but no substantial participation |
| | defined as threshold A. |
| 3 | “Bronze Status”- the passenger has a history that is |
| | substantial or more than an incidental threshold A and can |
| | be defined as threshold B |
| 4 | “Silver Status”- the passenger has a history that is more |
| | than another threshold B and can be defined as threshold C |
| 5 | “Gold Status”- the passenger has a history that is more than |
| | another threshold C and can be defined as threshold D. |

Different types of codes may also be used by rules engine 113. For example, Table 2 shows a listing of exemplary values associated with a code called classOfService that may represent a particular cabin in which airline passengers previously paid with regard to a disrupted flight.

TABLE 2
classOfService Codes

| | |
|---|---|
| F | First Class |
| Y | Coach Cabin |

Methods, systems, and articles of manufacture consistent with certain features related to the present invention may also employ rules that rank certain types of passengers. Rules engine 113 may be used by passenger flow model software 116 when performing the re-accommodation process consistent with certain features related to the present invention. Table 3 shows an exemplary listing of how passengers may be ranked based on their profile.

TABLE 3
Passenger Prioritization

| Rank | Passenger Profile |
|---|---|
| 1 | Physically challenged unaccompanied |
| | minor |
| 2 | Physically challenged adult or |
| | accompanied minor |
| 3 | Unaccompanied minor |
| 4 | Political VIP (Senator, congressman or |
| | congresswoman, etc.) |
| 5 | Very elderly passengers |
| 6 | Top Premium Tier Frequent Flier |
| 7 | First Class Fare Passengers |
| 8 | Second Premium Tier Frequent Flier |
| 9 | Third Premium Tier Frequent Flier |
| 10 | Full Economy Fare Passengers |
| 11 | Passengers connecting to tours or cruises |
| 12 | International Passengers |
| 13 | Groups of 3 or more at discounted fares |
| 14 | Progressively lower discounted fare |
| | amounts |

Passenger flow model flow model software 116 may perform a passenger flow model re-accommodation process consistent with certain features related to the present invention and may be implemented, for example, using the commercially available AMPL and/or C++ programming languages. One skilled in the art would realize that any number of different programming languages may be implemented without departing from the spirit and scope of the present invention.

Monitor 115 may be any know display device that allows computer 102 to present information. I/O controller 114 may be a bus controller, network communications device, or similar device for controlling communications to and from computer 102. Notification service 140 may be a set of instructions that, when executed by a processor, performs a service that provides re-accommodation information associated with certain features consistent with the present information. Notification service 140 may generate and provide notification information (e.g., message) to one or more external entities, such as a disrupted passenger, one or more travel providers, travel agent services, and any other entity that is associated with the travel industry to provide notifications of re-accommodations. In one aspect of the invention, notification service 140 may provide a notification comprising text, email, and/or voice enabled messages containing information on an operation disruption (e.g., cancellation) and a re-accommodation. The messages may be formatted for delivery over an selected medium and sent to a receiving entity after re-accommodation is determined. For instance, an exemplary message be as follows:

Hello! This is the Sabre automated reaccommodation agent. Your flight from <origin> to <destination> has been rebooked. You have been automatically rebooked on the following flight(s):

<carrier> flight <number> from <origin> to <destination> on MM/DD/YYYY departing at hh:mm arriving at hh:mm Please call (888) 555-1212 for more information.

Although FIG. 1 shows notification service 140 within computer 102, one skilled in the art would realize that the service may be located remotely from computer 102 and executed by remote processing devices and/or systems.

Operations database 118 may include one or more storage devices that store flight data used by system 100 for implementing a Passenger Flow Model (PFM). In one aspect consistent with certain principles related to the present invention, operations database 118 may be a database that stores flight data associated with an airline flight tracking system, such as Sabre AirOps. The flight data may include, for example, the following data: unique flight identification, departure station (e.g., airport), arrival station, scheduled departure time, revised departure time, scheduled arrival time, revised arrival time, authorization limit (virtual aircraft capacity), operational status (equal to one if flown, zero otherwise), minimum passenger connect time, and a matrix of allowable co-terminal airports in the network. Minimum passenger connect time is an industry standard minimum required transfer time at a given airport. For example, a minimum passenger connect time might be set for 40 minutes because it may not be realistic to assume that every passenger can make it to a connecting flight in less than 40 minutes. Operations database 118 may be implemented, for example, using a relational database architecture.

Passenger database 120 may be one or more storage devices that store passenger information used for implementing a PFM re-accommodation process in accordance with the present invention. In one configuration, passenger database 120 may be an intermediate passenger database associated with a computer reservation system (CRS) such as those known or referred to under the following trade names and service marks: SABRE, AMADEUS, WORLDSPAN, SYSTEM ONE, APOLLO, GEMINI, GALILEO, AXESS, INFINI, and SHARES.

Alternatively, the passenger information may be obtained from the departure control system, which is the computer system used at the gate before check-in. The passenger information may, for example, include the following data: unique origin-destination-fare ODF, average fare for a given PNR (passenger name record), number of booked passengers for a given PNR, and flight itinerary for a given PNR. Generally, a flight itinerary includes the origin and destination, along with other information, such as dates, times, class of service, etc. Passenger database 120 may be implemented, for example, using a relational database architecture. Furthermore, other additional passenger information may be obtained from external sources, such as passenger travel history, behavior and profile databases (not shown).

In one configuration consistent with certain principles related to the present invention, passenger history, behavior, and profile databases (not shown) may be used to establish an overall ranking of a disrupted passenger. These databases may be maintained by individual travel service providers (i.e., carriers), and thus, may vary based on the business practices of each individual carrier. These database may include passenger information that may not be located in passenger database 120 (at least originally). The additional passenger information may include, but is not limited to, a number of flights a passenger has purchased on a particular carrier over a period of time (i.e., frequent flier information), the personal profile status of the passenger, and the average cost of the passenger's travel history. One skilled in the art would realize that other types of passenger information may be maintained in these and other databases, and the present invention is not limited to the above examples.

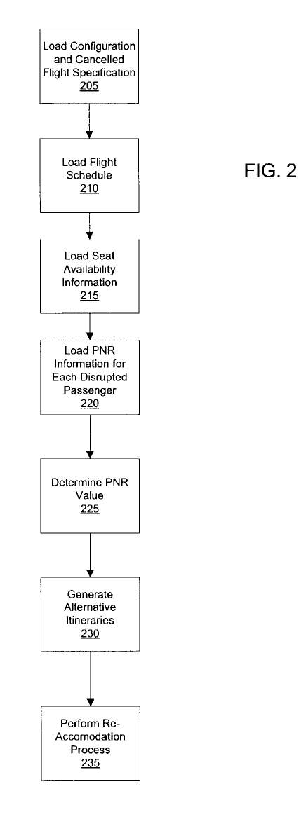

FIG. 2 illustrates an flowchart of an exemplary process performed by computer environment 100 following a disruption in a travel service. Although the method in FIG. 2 is described with respect to an exemplary disrupted airline flight, one skilled in the art would appreciate that the method may be applied to other types of travel services. Following an airline flight disruption (e.g., operational disruption), an airline entity, travel agent, or other travel based entities, may determine to re-accommodate disrupted passengers. Accordingly, re-accommodation driver 111 may load disrupted flight specification information from configuration file 112, which is updated automatically to reflect the change in travel services based on the disruption (Step 205). Re-accommodation driver 111 may retrieve flight schedule information from operations database 118 (Step 210). Also, re-accommodation driver 111 may retrieve from operations database 118 seat availability information associated with each flight included in the flight schedule information (Step 215). Further, re-accommodation driver 111 may retrieve a Passenger Name Record (PNR) list associated with the disrupted flight from a PNR data structure that may be located in operations database 118 or another storage device. (Step 220). For example, the PNR data structure may be located in a database remote from operations database 118.

Once the flight, seat, and PNR information is collected, re-accommodation driver 111 may determine a PNR value for a disrupted passenger (Step 225). In one aspect of the invention, re-accommodation driver 111 may determine a PNR value for the disrupted passenger by invoking instructions included in rules engine 113 that, when executed by a processor, determine a PNR value based on one or more rules associated with the disrupted flight and/or passenger. For example, the PNR value may be based, in part, from an actual fare amount the disrupted passenger previously paid for the disrupted flight. Fare amounts, however, are not always easily obtainable from PNR information because they may be located in multiple locations and formats in a PNR. Moreover, fare amounts may not even be found in a PNR. Accordingly, in some instances it may be difficult to assess the exact amount of a given segment of an itinerary associated with the disrupted flight because it might be a prorated value of a larger itinerary. Furthermore, reservations received, ticketed, and/or processed from an external source may not contain any fare information. Therefore, rules engine 113 may provide a set of instructions, that when executed by a processor, determines an equitable fare amount for each booking class affected by the disrupted flight in order to determine a PNR value for each disrupted passenger.

In one configuration consistent with certain features related to the present invention, rules engine 113 and/or re-accommodation driver 111 determines the PNR value based on a pre-processed calculation that assigns average cents per mile to fares associated with a given booking class within various flight ranges, such as 0-500, 500-1000, 1000-1500, etc. (fares tend to be lower in cents per mile as length of flight increases). Accordingly, rules engine 113 may accumulate all the fares within a given booking class for a given airline, divide those fares by a segment mileage, then average the cents per mile within a given mileage range. The cents per mile average for each booking class is multiplied by the distance of the disrupted segment to assign a totalFarePaid value for determination of passenger value (PNR value) on the disrupted segment.

In one configuration consistent with certain features related to the present invention, the totalFarePaid may be considered as the passenger value of a disrupted passenger (PNR value) unless the totalFarePaid value can be increased by a frequent flyer status and/or a class of service code. For example,

if ( frequentFlyerStatus==4 && classOfService==“F”) then

PassengerValue=160000+totalFarePaid;

end

One skilled in the art would realize that similar rules may be used for different frequentFlyerStatus and classOfService groupings.

Returning to FIG. 2, once a PNR value has been determined, re-accommodation driver 111 may create one or more passenger flow model (PFM) input files for use by the PFM process performed by PFM software 116 consistent with certain features of the present invention. A PFM input file may include the flight schedule and PNR data previously collected by computer 102 in steps 215 and 220. PFM software 116, when executed by a processor, may access the PFM input files to allow the PFM process to determine alternative itineraries for the disrupted flight (Step 230). The PFM process may determine alternative itineraries in a manner similar to the PFM process described in U.S. application Ser. No.: 09/635,213, filed Aug. 9, 2000, entitled, “METHOD AND SYSTEM FOR APPARATUS FOR DETERMINING THE IMPACT OF SCHEDULE CHANGES ON PASSENGER FLOW,” which is hereby incorporated by reference in its entirety. For example, consider an exemplary scenario where a weather condition affects the travel schedule of a plurality of airline flights departing from an origination airport. The weather condition may cause airlines to cancel 20 out of 40 flights that were to depart from the origination airport. Based on the canceled flights, PFM process may determine alternative itineraries from the remaining 20 available flights departing from the airport.

After passenger flow model software 116 determines one or more alternative itineraries, they may be placed in an output file (not shown). Re-accommodation driver 111 may access the output file to perform a re-accommodation process that attempts to rebook a disrupted passenger on an alternate itinerary (Step 235).

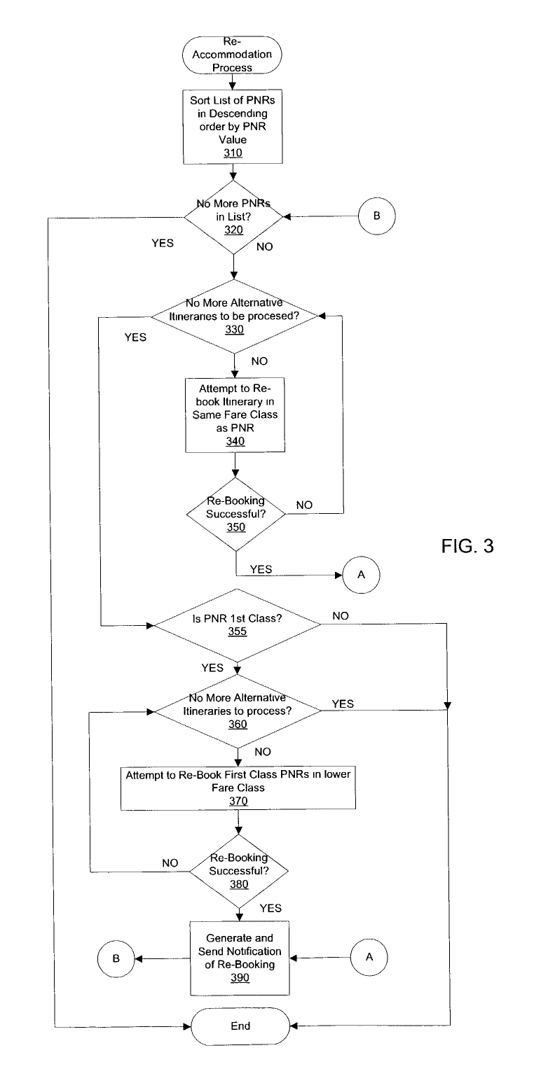

FIG. 3 shows a flowchart of an exemplary re-accommodation process that may be performed by re-accommodation driver 111. Initially, the PNR list obtained in Step 220 may be sorted in a particular order (e.g., descending order) based on PNR value (Step 310). Once sorted, the re-accommodation process identifies a PNR in the list, (initially this may be the first PNR) and determines whether all the PNRs in the list have been processed (Step 320). If so, the process ends (Step 320; YES). However, if not all of the PNRs in the list have been processed, the process continues (Step 320; NO). Next, the process attempts to rebook the alternative itinerary with the same fare class as the identified PNR (e.g., coach class) (Steps 330-350). Each alternative itinerary is analyzed, possibly in descending value order, with the identified PNR (Step 330) until either a successful booking is obtained (Step 350; YES) or no available itineraries were located (Steps 350; NO, and 330; YES). If a rebooking was successful, the process continues at Step 390.

On the other hand, if rebooking was unsuccessful and there are no more alternative itineraries to process (Steps 350; NO and 330; YES), the process determines whether the identified PNR includes a first class fare class (Step 355). If not, the process ends. However, if the PNR has first class status (Step 355; YES), the process attempts to rebook the alternative itinerary in a lower fare class as that of the identified PNR (Steps 360-380). Each alternative itinerary is analyzed, possibly in descending value order, with the identified PNR (Step 360), until either a successful booking obtained (Step 380; YES) or no available itineraries was located (Steps 380; NO, and 360; YES). If no rebooking was obtained, the process ends. However, if a rebooking was successful, the process continues at Step 390. It should be noted that one skilled in the art would realize that other fare classes may be identified and adjusted. For example, the process may attempt to rebook PNRs that are associated with a business class to a lower fare class.

At Step 390, re-accommodation process 111 may use notification service 140 to provide an automated and immediate (e.g., near real-time) indication of the successful rebooking to the source or beneficiary of the rebooking request, such as the airline, travel agent, and even the disrupted passenger (Step 390). In one aspect of the invention, the disrupted passenger notification media is pre-determined by the passenger based upon certain preferences, such as wireline or wireless telephone, internet, personal digital assistant, and pager notifications. Following notification, the re-accommodation process shown in FIG. 2 may repeat for each PNR in the PNR list until all disrupted passengers are processed for rebooking (Steps B, and 320).

As described, methods, systems, and articles of manufacture consistent with features of the present invention allow a disrupted passenger to be rebooked on alternative itineraries when a travel disruption occurs. The features and principles consistent with the present invention may be implemented with non-airline travel suppliers, such as hotels, and car rental businesses. For example, when computer 102 determines rebooking information, the non-airline travel suppliers may also be notified of the changes to a disrupted passenger's itinerary. This may allow these suppliers to adjust their schedules and itineraries to compensate for the disruption. Thus, an itinerary associated with a packaged tour that may include a disrupted airline flight segment, hotel segment, and a cruise segment, may be adjusted by each of the suppliers based on rebooking notifications provided by computer 102. Therefore, methods, systems, and articles of manufacture consistent with certain principles related to the present invention provide a customer service that can be extended to a publish and subscribe system (i.e., computer 102) to any travel supplier who participates within a multi-supplier network. For example, if multiple services such as air, car rental, hotel, tour, etc. are booked within the individual travel supplier's computer database, but a record of a total trip for a passenger is stored and/or managed within a central database, then, any disruption can initiate re-accommodation of not just the disrupted service, but also ancillary services within the customer's entire trip that are affected by the disruption.

Also, the rules used by rules engine 113 and the re-accommodation process consistent with features of the present invention are not limited to airlines and may be associated with travel agents, and other travel-based entities. For example, a travel agent may establish rules and ranking criteria associated with their customers such that when a customer's itinerary has been disrupted, the re-accommodation of the customer is based on the “value” of the customer compared to other customers. Furthermore, methods, systems, and articles of manufacture consistent with certain features related to the present invention may allow the re-accommodation process to be performed without some or all of the rules maintained by the rules engine 113. Thus, in one configuration consistent with certain features of the present invention may allow one or more rules to be modified, activated, or de-activated to control how the re-accommodation process determines the value of disrupted passengers. For example, a travel service provider that implements methods and systems consistent with the present invention may dynamically de-activate one or more rules (e.g., frequent flier based rule, a fare paid rule, etc.) prior, during, or following an operational disruption.

Variations of the methods and systems consistent with features of the present invention previously described may be implemented without departing from the scope of the invention. For example, aspects consistent with certain features related to the present invention may allow a disrupted passenger to be re-accommodated to an alternative itinerary that provides a travel service different from an original travel service booked by the passenger. For example, the re-accommodation process may provide a disrupted passenger that originally had a seat on an airline flight from Las Vegas to Washington, D.C., with an alternative itinerary that includes travel from Las Vegas to Washington, D.C. on a train or bus service. Alternatively, re-accommodation process may re-accommodate the disrupted passenger with a combination of alternative travel services, such as bus service for one leg of the trip, train service on another leg, and an alternative flight on a final leg. Also, the re-accommodation process may determine alternative source and/or destination locations that are within a predetermined distance from an original source and/or destination location included in a disrupted itinerary.

Additionally, the re-accommodation process may determine alternative itineraries that include departure and/or arrival times of a travel service within a determined period of time of a departure and/or arrival time associated with a travel service included in the disrupted itinerary. For example the re-accommodation process may re-accommodate a disrupted passenger based on a comparison with other disrupted passengers associated with an alternative itinerary. For instance, consider two passengers, P1 and P2, that are originally booked on a flight that departs from a source location at 6:00 AM. Further consider that following a disruption of the booked flight, re-accommodation process determines that there are two flights, each with one available seat, that depart from the same source location at varying times, such as leaving at 6:30 AM and 8:30 AM. Based on a passenger value associated with P1 and P2, re-accommodation process may rebook the disrupted passengers on a respective alternative itinerary. Thus, if P1 has a higher passenger value than P2, re-accommodation process may rebook P1 on the 6:30 AM departing flight because it has a departing time closer to departure time of the disrupted flight. Accordingly, passenger P2 will be rebooked on the remaining 8:30 AM flight.

Further, methods, systems, and articles of manufacture, consistent with features of the present invention may be implemented using various components, network models, etc. and are not limited to the examples described above. Also, any number of programming languages may be utilized without departing from the scope of the present invention.

Additionally, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described aspects of the invention, but instead is defined by the appended claims in light of their full scope of equivalents.

What is claimed is:

1. A method for re-accommodating a disrupted passenger associated with a disrupted travel service, comprising:
determining a passenger value for a disrupted passenger;
determining an alternative itinerary for the disrupted travel service;
rebooking the disrupted passenger on the alternative itinerary based the determined passenger value; and
notifying at least one of the disrupted passenger and a travel service provider of the rebooking.

2. The method of claim 1, wherein determining a passenger value for the disrupted passenger includes:
determining the passenger value based on a function of a relationship of the disrupted passenger with the travel service provider.

3. The method of claim 1, wherein determining a passenger value for the disrupted passenger includes:
determining the passenger value based on at least one of a class of service, a frequent flier status, a fare paid status, a group travel status, an international travel status, a VIP status, a physical condition, and an age associated with the disrupted passenger.

4. The method of claim 1, wherein determining a passenger value for the disrupted passenger is performed by a rules engine maintained by the travel service provider.

5. The method of claim 1, wherein the disrupted travel service is associated with a departing and arrival time, and wherein determining an alternative itinerary includes:
determining an alternative itinerary for the disrupted travel service based on available alternative travel services each associated with at least one of an alternative arrival and departing time within a predetermined period of time of the arrival and departing time, respectively, of the disrupted travel service.

6. The method of claim 1, wherein the disrupted passenger is rebooked on the alternative itinerary based on a preference of the passenger value of the disrupted passenger over a passenger values associated with another disrupted passenger.

7. The method of claim 1, wherein rebooking the disrupted passenger is performed automatically following a detection of the disrupted service.

8. The method of claim 1, wherein notifying at least one of the disrupted passenger and a travel service provider of the rebooking includes:
notifying the disrupted passenger of the rebooking through at least one of a wireline telephone medium, a wireless telephone medium, and a network data communication medium.

9. The method of claim 8, wherein notifying the disrupted passenger includes:
providing a text based message including information reflecting the alternative itinerary.

10. The method of claim 8, wherein notifying the disrupted passenger includes:
providing a voice based message including information reflecting the alternative itinerary.

11. The method of claim 1, wherein the disrupted passenger is notified of the rebooking through a medium previously selected by the disrupted passenger.

12. The method of claim 1, wherein determining a passenger value includes:
identifying an average cost per mile for a plurality of travel service providers in a plurality of service classes;
determining a modified cost per mile for each average cost per mile within different mileage ranges; and
determining the passenger value for the disrupted passenger based on a modified cost per mile that is applied to a class of service and a mileage of the disrupted travel service.

13. A method for determining a value associated with a passenger booked on a disrupted airline flight associated with a disrupted itinerary segment, comprising:
identifying an average cost per mile for a plurality of airlines in a plurality of service classes;
determining a modified cost per mile for each average cost per mile within different mileage ranges; and
determining a fare value for the disrupted passenger based on a modified cost per mile that is applied to a class of service and a mileage of the disrupted itinerary segment.

14. A system for re-accommodating a disrupted passenger booked on a first airline flight, comprising:
a rules engine for maintaining one or more rules associated with travel based passengers, wherein the rules engine is configured to determine a value associated with the disrupted passenger based on the one or more rules;
a flight memory for storing flight information associated with a plurality of airline flights;
a passenger memory for storing passenger information associated with the travel based passengers;
a re-accommodation component for rebooking the disrupted passenger on a second airline flight based on at least one of the value, the flight information, and passenger information associated with the disrupted passenger; and
a notification component for notifying at least one of the disrupted passenger and travel based entity of the rebooking.

15. The system of claim 14, wherein the travel based entity is one of an airline, a travel agent entity, an entity that provides packaged travel tours, a hotel based entity, and a vehicle rental based entity.

16. The system of claim 14, wherein the one or more rules may be at least one of, provided, modified, activated, deactivated, and deleted, by one of an airline and a travel agent based entity.

17. The system of claim 14, wherein the rules engine may be deactivated such that the re-accommodation driver determines rebooks the disrupted passenger without considering the one or more rules maintained in the rules engine.

18. A method for receiving a notification of a disrupted travel service, comprising:
receiving a notification of a rebooking of an itinerary associated with a disrupted travel service previously booked, wherein the travel service is disrupted within a close proximity of time of a departure time included in the itinerary of the booked travel service.

19. The method of claim 18, wherein the close proximity of time is a 24 hour period of time.

20. The method of claim 18, wherein the notification is received through a medium selected prior to the disruption.

21. The method of claim 18, wherein the notification includes a message identifying an alternative itinerary to the itinerary associated with the disrupted travel service.

22. A computer-readable medium including instructions for performing a method, when executed by a processor, for re-accommodating a disrupted passenger associated with a disrupted travel service, the method comprising:
determining a passenger value for a disrupted passenger;
determining an alternative itinerary for the disrupted travel service;
rebooking the disrupted passenger on the alternative itinerary based the determined passenger value; and
notifying at least one of the disrupted passenger and a travel service provider of the rebooking.

23. The computer-readable medium of claim 22, wherein determining a passenger value for the disrupted passenger includes:
determining the passenger value based on a function of a relationship of the disrupted passenger with the travel service provider.

24. The computer-readable medium of claim 22, wherein determining a passenger value for the disrupted passenger includes:
determining the passenger value based on at least one of a class of service, a frequent flier status, a fare paid status, a group travel status, an international travel status, a VIP status, a physical condition, and an age associated with the disrupted passenger.

25. The computer-readable medium of claim 22, wherein determining a passenger value for the disrupted passenger is performed by a rules engine maintained by the travel service provider.

26. The computer-readable medium of claim 22, wherein the disrupted travel service is associated with a departing and arrival time, and wherein determining an alternative itinerary includes:
determining an alternative itinerary for the disrupted travel service based on available alternative travel services each associated with at least one of an alternative arrival and departing time within a predetermined period of time of the arrival and departing time, respectively, of the disrupted travel service.

27. The computer-readable medium of claim 22, wherein the disrupted passenger is rebooked on the alternative itinerary based on a preference of the passenger value of the disrupted passenger over a passenger values associated with another disrupted passenger.

28. The computer-readable medium of claim 22, wherein rebooking the disrupted passenger is performed automatically following a detection of the disrupted service.

29. The computer-readable medium of claim 22, wherein notifying at least one of the disrupted passenger and a travel service provider of the rebooking includes:
notifying the disrupted passenger of the rebooking through at least one of a wireline telephone medium, a wireless telephone medium, and a network data communication medium.

30. The computer-readable medium of claim 29, wherein notifying the disrupted passenger includes:
providing a text based message including information reflecting the alternative itinerary.

31. The computer-readable medium of claim 29, wherein notifying the disrupted passenger includes:
providing a voice based message including information reflecting the alternative itinerary.

32. The computer-readable medium of claim 22, wherein the disrupted passenger is notified of the rebooking through a medium previously selected by the disrupted passenger.

33. The computer-readable medium of claim 22, wherein determining a passenger value includes:
identifying an average cost per mile for a plurality of travel service providers in a plurality of service classes;
determining a modified cost per mile for each average cost per mile within different mileage ranges; and
determining the passenger value for the disrupted passenger based on a modified cost per mile that is applied to a class of service and a mileage of the disrupted travel service.

34. A computer-readable medium including instructions for performing a method, when executed by a processor, for determining a value associated with a passenger booked on a disrupted airline flight associated with a disrupted itinerary segment, the method comprising:
identifying an average cost per mile for a plurality of airlines in a plurality of service classes;
determining a modified cost per mile for each average cost per mile within different mileage ranges; and
determining a fare value for the disrupted passenger based on a modified cost per mile that is applied to a class of service and a mileage of the disrupted itinerary segment.

35. A system for re-accommodating a disrupted passenger associated with a disrupted travel service, comprising:
means for determining a passenger value for a disrupted passenger;
means for determining an alternative itinerary for the disrupted travel service;
means for rebooking the disrupted passenger on the alternative itinerary based the determined passenger value; and
means for notifying at least one of the disrupted passenger and a travel service provider of the rebooking.

36. A system for determining a value associated with a passenger booked on a disrupted airline flight associated with a disrupted itinerary segment, comprising:
means for identifying an average cost per mile for a plurality of airlines in a plurality of service classes;
means for determining a modified cost per mile for each average cost per mile within different mileage ranges; and
means for determining a fare value for the disrupted passenger based on a modified cost per mile that is applied to a class of service and a mileage of the disrupted itinerary segment.
